(19) United States
(12) Patent Application Publication
(10) Pub. No.: US 2024/0086700 A1
(43) Pub. Date: Mar. 14, 2024

(54) Method Of Training Local Neural Network Model For Federated Learning

(71) Applicant: DEARGEN INC., Daejeon (KR)

(72) Inventors: Yeachan KIM, Gyeonggi-do (KR); Bonggun SHIN, Gyeongsangbuk-do (KR)

(73) Assignee: DEARGEN INC., Daejeon (KR)

(21) Appl. No.: 17/944,650

(22) Filed: Sep. 14, 2022

(51) Int. Cl. G06N 3/08

(52) U.S. Cl. CPC G06N 3/08

(57) ABSTRACT

The present disclosure relates to training a local neural network model based on federated learning in consideration of a heterogeneous environment in which training data are different from each other. An exemplary embodiment of the present disclosure provides a method of training a local neural network model based on federated learning, the method being performed by at least one computing device, the method including: calculating a difference between a global neural network model and a local neural network model; determining an additional regularization for training the local neural network model based on the calculated difference; and training the local neural network model based on a loss function including the determined additional regularization.

### TECHNICAL FIELD

The present disclosure relates to a method of training a neural network model for federated learning, and particularly, to a method of training a local neural network model for federated learning.

### BACKGROUND ART

Federated learning is a method in which multiple participants with different data learn a single neural network without sharing data with each other. For example, federated learning is a learning method in which a neural network model received from a server is individually trained by using training data and processor resources stored in a plurality of devices, and then the neural network models individually trained in the plurality of devices are transmitted to the server and collected. The federated learning makes it possible for a large number of people to participate in training a single neural network model by using an individual device. Due to this point, since the training can be performed on each device, there are advantages in that it is easy to secure a wide range of training data, and there is little risk to personal information protection and security information because the training data is not exposed to the server.

For example, in the medical field dealing with patient's personal information, even though a neural network model is to be trained based on the patient's medical information, it may be difficult to train the neural network model while protecting the patient's personal information. Therefore, the federated learning that can train a single neural network model without exposing individual data to the outside is attracting attention.

However, when the federated learning is performed in a heterogeneous environment in which the distribution of learning data among participants is significantly different, there is a problem in that learning performance may be deteriorated. In this case, the cause of the problem may be due to a difference (for example, drift) between the training direction of the global neural network included in the server and the training direction of the local neural network trained by the participant.

In other words, new methods are needed to solve the problem caused by excessive optimization differences between local and global neural networks.

The federated learning referred to in the present disclosure may be understood from “Tian Li et al., Federated Learning: Challenges, Methods, and Future Directions. IEEE. IEEE Signal Processing Magazine. May 2020. Volume 37. No. 5. pp. 50˜60 (2020 May 6)”. However, the applicable scope of the present disclosure is not limited thereto, and the present disclosure may also be applied to a similar improved or derived learning method.

### SUMMARY OF THE INVENTION

The present disclosure has been conceived in response to the foregoing background art, and has been made in an effort to train a local neural network model based on federated learning in consideration of a heterogeneous environment in which training data are different from each other.

The purpose of the present disclosure is not limited to the above-mentioned purpose, and other objects and advantages of the present disclosure that are not mentioned may be understood by the following description, and will be more clearly understood by the examples of the present disclosure. Moreover, it will be readily apparent that the objects and advantages of the present disclosure may be realized by the means and combinations thereof indicated in the claims.

In order to solve the foregoing object, an exemplary embodiment of the present disclosure discloses a method of training a local neural network model based on federated learning, the method being performed by at least one computing device, the method including: calculating a difference between a global neural network model and a local neural network model; determining an additional regularization for training the local neural network model based on the calculated difference; and training the local neural network model based on a loss function including the determined additional regularization.

In the alternative exemplary embodiment, the calculating of the difference between the global neural network model and the local neural network model may include: calculating differences between output values of respective layers of the global neural network model and output values of corresponding respective layers of the local neural network model; and identifying the largest difference among the calculated differences.

In the alternative exemplary embodiment, the calculating of the difference between the global neural network model and the local neural network model may include calculating a difference between an output value of the last layer of the global neural network model and an output value of the last layer of the local neural network model.

In the alternative exemplary embodiment, the calculating of the difference between the global neural network model and the local neural network model may include calculating a difference between an output value of a predetermined layer of the global neural network model and an output value of a predetermined layer of the local neural network model.

In the alternative exemplary embodiment, the calculating of the difference between the output value of the last layer of the global neural network model and the output value of the last layer of the local neural network model may include calculating difference between a value obtained by applying a normalized class classification function to the output value of the last layer of the global neural network model and taking a logarithm and a value obtained by applying the normalized class classification function to the output value of the last layer of the local neural network model and taking a logarithm.

In the alternative exemplary embodiment, the normalized class classification function may calculate an output value by utilizing an angle between an input vector and a vector indicating a class of the last layer.

In the alternative exemplary embodiment, the determining of the additional regularization for training the local neural network model based on the calculated difference may include: obtaining a negative value (−D) of the calculated difference (D); and determining the additional regularization by using the negative value (−D) of the calculated difference (D).

In the alternative exemplary embodiment, the additional regularization may be determined based on a value obtained by applying a normalized class classification function to an output value of the last layer of the local neural network model and taking a logarithm; and a value obtained by applying the normalized class classification function to the negative value (−D) of the calculated difference (D).

In the alternative exemplary embodiment, the additional regularization may be determined additionally based on a hyper-parameter for adjusting intensity of the regularization.

In the alternative exemplary embodiment, the hyper-parameter may be determined to be proportional to a heterogeneous environment distribution of data related to the federated learning.

In the alternative exemplary embodiment, the loss function may include a cross entropy loss value and a value based on the additional regularization, and the local neural network model may be trained in a direction to reduce a difference between the global neural network model and the local neural network model while learning local data based on the loss function.

Another exemplary embodiment of the present disclosure provides an apparatus for training a local neural network model based on federated learning, the apparatus including: a processor including one or more cores; and a memory, in which wherein the processor calculates a difference between a global neural network model and the local neural network model, determines an additional regularization for training the local neural network model based on the calculated difference, and trains the local neural network model based on a loss function including the determined additional regularization.

Still another exemplary embodiment of the present disclosure provides a computer program stored in a computer-readable storage medium, the computer program causing a processor to perform operations for training a local neural network model based on federated learning, the operations including: calculating a difference between a global neural network model and the local neural network model; determining an additional regularization for training the local neural network model based on the calculated difference; and training the local neural network model based on a loss function including the determined additional regularization.

According to the present disclosure, in relation to federated learning, it is possible to prevent the performance degradation problem that may occur due to the difference between the local neural network model and the global neural network model.

### BRIEF DESCRIPTION OF THE DRAWINGS

FIG. 1 is a block diagram illustrating a training computing device for training a local neural network model based on federated learning according to an exemplary embodiment of the present disclosure.

FIG. 2 is a schematic diagram illustrating a network function according to the exemplary embodiment of the present disclosure.

FIG. 3 is a schematic diagram for explaining federated learning before describing the exemplary embodiment of the present disclosure.

FIG. 4 is a flowchart illustrating a method of training a local neural network model based on federated learning according to the exemplary embodiment of the present disclosure.

FIG. 5 is a flowchart illustrating a method of training a local neural network model based on a difference between output values of layers of a global neural network and a local neural network according to the exemplary embodiment of the present disclosure.

FIG. 6 is a flowchart illustrating a method of training a local neural network model based on a difference between output values of last layers of the global neural network and the local neural network according to the exemplary embodiment of the present disclosure.

FIG. 7 is a graph illustrating a result of a test performed by using an additional regularization that is a method according to the exemplary embodiment of the present disclosure.

FIG. 8 is a simple and general schematic diagram for an example of a computing environment in which exemplary embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system” and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers.

Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations has been generally described above in the functional aspects thereof. Whether the functionality is implemented as hardware or software depends on a specific application or design restraints given to the general system. Those skilled in the art may implement the functionality described by various methods for each of the specific applications. However, such implementation decisions should not be interpreted as causing a departure from the scope of the present disclosure.

The description of the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, a network function, an artificial neural network, and a neural network may be used interchangeably, and a neural network model used in the present disclosure may be understood as a model including those related to the above-mentioned network function.

The federated learning method according to the present disclosure, which will be described below, may prevent a performance degradation problem that may occur due to a difference (for example, drift) between a local neural network model and a global neural network model.

For example, the present disclosure may calculate a difference between a global neural network model and a local neural network model and determine an additional regularization for training of the local neural network model based on the difference. In addition, in the present disclosure, when the direction of training data learned by the local neural network model is different from the direction of the global neural network model, the training of the local neural network model may be corrected by adjusting a loss value generated in the loss function based on the additional regularization.

Accordingly, the present disclosure may prevent performance degradation due to client-drift, catastrophic forgetting, and the like. In addition, in the present disclosure, in federated learning in which an unspecified number of people may participate in training, it is possible to solve a problem occurring when a local neural network model is trained based on a dataset including training data that is not maliciously or unintentionally related to the learning goal in a specific environment, and the present disclosure may implement various technical effects in addition to the foregoing technical effect. On the other hand, the difference (for example, drift) between the local neural network model and the global neural network model differs only in degree depending on the distribution of the training data of the local neural network model, and generally always occurs during federated learning, so that the present disclosure may be implemented in the various exemplary embodiments related to the federated learning.

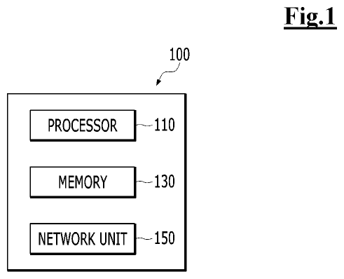

FIG. 1 is a block diagram illustrating a training computing device for training a local neural network model based on federated learning according to an exemplary embodiment of the present disclosure.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

The computing device 100 may include a processor 110, a memory 130, and a network unit 150.

The processor 110 may be formed of one or more cores, and may include a processor, such as a central processing unit (CPU), a general purpose graphics processing unit (GPGPU), and a tensor processing unit (TPU) of the computing device, for performing a data analysis and deep learning. The processor 110 may read a computer program stored in the memory 130 and process data for machine learning according to an exemplary embodiment of the present disclosure. According to the exemplary embodiment of the present disclosure, the processor 110 may perform calculation for training a neural network. The processor 110 may perform a calculation, such as processing of input data for training in Deep Learning (DL), extraction of a feature from input data, an error calculation, and updating of a weight of the neural network by using backpropagation, for training the neural network.

At least one of the CPU, GPGPU, and TPU of the processor 110 may process training of a network function. For example, the CPU and the GPGPU may process training of the network function and data classification by using a network function together. Further, in the exemplary embodiment of the present disclosure, the training of the network function and the data classification by using a network function may be processed by using the processors of the plurality of computing devices together. Further, the computer program executed in the computing device according to the exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to the exemplary embodiment of the present disclosure, the memory 130 may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device 100 may also be operated in relation to web storage performing a storage function of the memory 130 on the Internet. The description of the foregoing memory is merely illustrative, and the present disclosure is not limited thereto.

The network unit 150 according to several exemplary embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

The network unit 150 in the present disclosure may be configured regardless of its communication mode, such as a wired mode and a wireless mode, and may be configured of various communication networks, such as a Personal Area Network (PAN) and a Wide Area Network (WAN). Further, the network may be the publicly known World Wide Web (WWW), and may also use a wireless transmission technology used in PAN, such as Infrared Data Association (IrDA) or Bluetooth. The techniques described herein may also be used in other networks mentioned above.

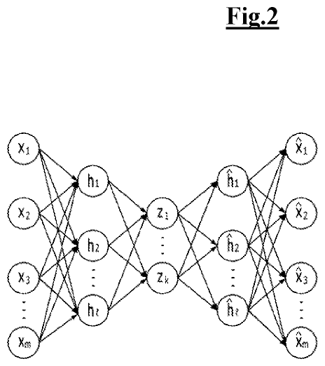

FIG. 2 is a schematic diagram illustrating a network function according to the exemplary embodiment of the present disclosure.

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

The difference between neural network models in the present disclosure may mean a difference in parameters in which nodes included in the neural network model are learned. In this case, the parameter may refer to a weight or a variable for similar purposes, and comparing each layer of the neural network model may include comparing an output value using a class classification function based on an output value of nodes included in each layer.

According to the embodiment of the present disclosure, a computer readable medium storing a data structure is disclosed.

The data structure may mean organization, management, and storage of data that enables efficient access and correction of the data. The data structure may mean organization of the data for solving a specific problem (for example, data search, data storage, and data correction in the shortest time). The data structure may also be defined as a physical or logical relation between data elements designed so as to support a specific data processing function. The logical relation between the data elements may include a connection relation between the data elements considered by the user. The physical relation between the data elements may include an actual relation between the data elements physically stored in the computer readable storage medium (for example, a hard disk). The data structure may particularly include a set of data, a relation between data, and a function or a command applicable to data. The computing device may perform the computation by minimally using the resources of the computing device through the effectively designed data structure. Particularly, the computing device may improve efficiency of computation, reading, insertion, deletion, comparison, exchange, and search through the effectively designed data structure.

The data structure may be divided into a linear data structure and a nonlinear data structure according to the form of the data structure. The linear data structure may be a structure in which only one data is connected after one data. The linear data structure may include a list, a stack, a queue, and a deque. The list may mean a series of data sets that are internally ordered. The list may include a linked list. The linked list may be a data structure in which each data is connected in a line with a pointer. The pointer in the linked list may include link information with next or previous data. The linked list may be expressed as a single linked list, a dual-linked list, a circular linked list according to the form. The stack may be a data listing structure limitedly accessible to data. The stack may be a linear data structure that may process (for example, insert or delete) data only at one end of the data structure. The data stored in the stack may be a data structure (Last in First Out (LIFO)), in which the later the data is stored, the faster the data comes out. The queue is a data listing structure limitedly accessible to data, and may be a data structure (First in First Out (FIFO)), in which the later the data is stored, the later the data comes out, unlike the stack. The deque may be a data structure that may process data at both ends of the data structure.

The nonlinear data structure may be the structure in which the plurality of data is connected after one data. The nonlinear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

The data structure may include a neural network. The data structure including the neural network may be stored in a computer readable medium. The data structure including the neural network may also include data input to the neural network, a weight of the neural network, a hyper parameter of the neural network, data obtained from the neural network, an active function associated with each node or layer of the neural network, and a loss function for training the neural network. The data structure including the neural network may include predetermined constituent elements among the disclosed configurations. That is, the data structure including the neural network may be formed of the entirety or a predetermined combination of data input to the neural network, a weight of the neural network, a hyper parameter of the neural network, data obtained from the neural network, an active function associated with each node or layer of the neural network, a loss function for training the neural network, and the like. In addition to the foregoing configurations, the data structure including the neural network may include other predetermined information determining a characteristic of the neural network. Further, the data structure may include any type of data used or generated in the computation process of the neural network, and is not limited to the foregoing matters. The computer readable medium may include a computer readable recording medium and/or a computer readable transmission medium. The neural network may be formed of a set of mutually connected calculation units which may be generally referred to as nodes. The nodes may also be referred to as neurons. The neural network includes one or more nodes.

The data structure may include data input to the neural network. The data structure including the data input to the neural network may be stored in the computer readable medium. The data input to the neural network may include training data input in the neural network training process and/or input data input to the neural network which is completely trained. The data input to the neural network may include preprocessed data and/or data to be preprocessed. The preprocessing may include a data processing process for inputting data to the neural network. Accordingly, the data structure may include the data to be processed and the data generated by the preprocessing. The foregoing data structure is merely an example, and the present disclosure is not limited thereto.

The data structure may include a weight of the neural network (in the present specification, the weight and the parameter may be used as the same meaning). Further, the data structure including the weight of the neural network may be stored in the compute readable medium. The neural network may include a plurality of weights. The weight may be variable, and in order for the neural network to perform a desired function, the weighted may be varied by a user or an algorithm. For example, when one or more input nodes are connected to one output node by links, respectively, the output node may determine an output node value based on the values input to the input nodes connected with the output node and a parameter set in the link corresponding to each of the input nodes. The foregoing data structure is merely an example, and the present disclosure is not limited thereto.

As a non-limited example, the weight may include a weight varied in a neural network training process and/or a weight when the neural network is completely trained. The weight varied in the neural network training process may include a weight at the start time of a training cycle and/or a weight varied during the training cycle. The weight when the neural network is completely trained may include a weight when the training cycle is completed. Accordingly, the data structure including the weight of the neural network may include a data structure including a weight varied in the neural network training process and/or a weight when the neural network is completely trained. Accordingly, it is determined that the weight and/or a combination of the respective weights are included in the data structure including the weight of the neural network. The foregoing data structure is merely an example, and the present disclosure is not limited thereto.

The data structure including the weight of the neural network may be stored in a computer readable storage medium (for example, a memory and a hard disk) after being subjected to a serialization process. The serialization may be the process of storing the data structure in the same or different computing device and converting the data structure into a form that may be reconstructed and used later. The computing device may serialize the data structure and transceive data through a network. The serialized data structure including the weight of the neural network may be reconstructed in the same computing device or the different computing device through deserialization. The data structure including the weight of the neural network is not limited to the serialization. Further, the data structure including the weight of the neural network may include a data structure (for example, B-Tree, Trie, m-way search tree, AVL tree, and Red-Black Tree in the nonlinear data structure) for improving efficiency of the computation while minimally using the resources of the computing device. The foregoing matter is merely an example, and the present disclosure is not limited thereto.

The data structure may include a hyper-parameter of the neural network. Further, the data structure including the hyper-parameter of the neural network may be stored in the computer readable medium. The hyper-parameter may be a variable varied by a user. The hyper-parameter may include, for example, a learning rate, a cost function, the number of times of the repetition of the training cycle, weight initialization (for example, setting of a range of a weight that is the target of the weight initialization), and the number of hidden units (for example, the number of hidden layers and the number of nodes of the hidden layer). The foregoing data structure is merely an example, and the present disclosure is not limited thereto.

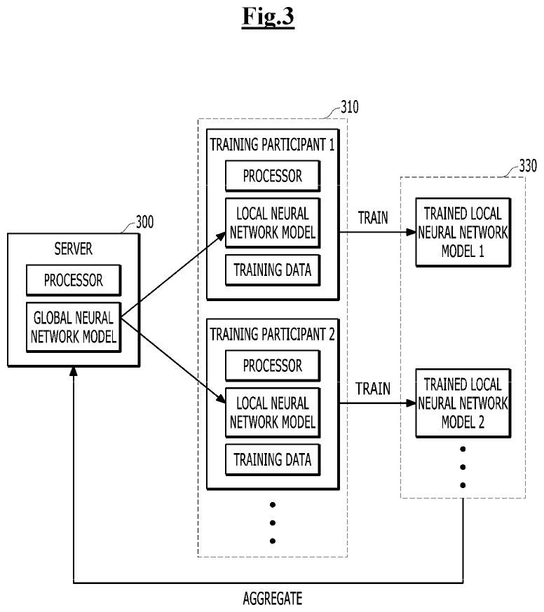

FIG. 3 is a schematic diagram for explaining federated learning before describing the exemplary embodiment of the present disclosure.

Concepts of federated learning necessary for describing the exemplary embodiments of the present disclosure will be described with reference to FIG. 3. The description with reference to FIG. 3, which will be discussed below, is an example of federated learning. The above examples are only for describing the exemplary embodiments of the present disclosure, and do not limit the present disclosure.

In performing federated learning on the global neural network model included in the server 300, the server 300 may allocate the global neural network to each of at least one training participant 310. Subsequently, the training participants 310 may train a local neural network model, which is the allocated global neural network model, based on individually owned training data and a processor. Finally, the server 300 may aggregate the trained local neural network models 330 and reflect the aggregated local neural network models 330 in the global neural network model.

In this case, the federated learning may be macroscopically classified into a ‘local learning stage’ and a ‘global aggregation stage’. In particular, the federated learning may be macroscopically classified into a “local learning stage” in which each of the training participants 310 is assigned a global neural network model included in the server 300 and trains the global neural network model, and a ‘global aggregation stage in which the server 300 aggregates the trained local neural network models 330 trained by each of the training participants 310 and trains the global neural network model. In this case, the training participant 310 may be understood as a computing device including a processor and local training data that may be different from each other, rather than referring to a natural person. Also, the server is not limited to a computer for a server, and may be understood as a computing device including a processor.

When the federated learning is performed as in the above example, the training data of the training participants 310 is not exposed to the server 300. This may be an advantage in terms of personal information protection, but even if the training participant 310 trains the local neural network model with training data that adversely affects the federated learning performance, it may be difficult for the server 300 to control the training participant 310.

On the other hand, in the actual federated learning environment, the distribution of the processor and the learning data may be different between the training participants 310, and the environment causing the different distribution is referred to as a heterogeneous environment in the present disclosure.

When the server 300 performs the global aggregation stage by using the local neural network models 330 trained in the heterogeneous environment, the performance of training the global neural network model may deteriorate. For example, there may occur a problem in that the local neural network models 330 trained in the heterogeneous environment interrupt convergence of the global neural network model. In addition, even in a local optimization stage, there may occur a problem in that optimization is interrupted by the heterogeneous environment. For example, in the process of performing the local optimization in the heterogeneous environment, performance degradation, such as catastrophic forgetting phenomenon of forgetting parameters aggregated in the previous global aggregation stage, may occur. On the other hand, as one of the main factors of performance degradation in the heterogeneous environment, there may be a difference (for example, drift) between the global neural network model and the local neural network model caused by the training in the heterogeneous environment.

In other words, in relation to federated learning, when a large difference between the global neural network model and the local neural network model is caused due to local optimization, learning performance may be degraded, so it is necessary to reduce the difference in order to improve the performance.

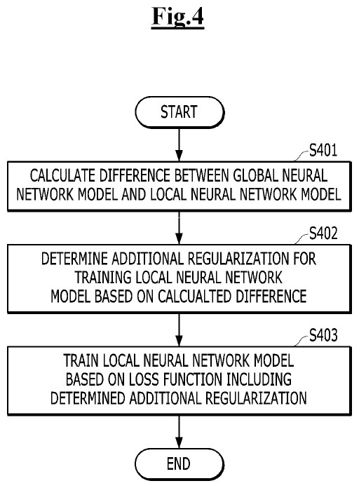

So far, an example of the federated learning for describing the exemplary embodiments of the present disclosure and others have been dealt with, with reference to FIG. 3. The exemplary embodiments for solving the problems of the present disclosure will be described based on FIGS. 4 to 6 below.

An exemplary embodiment of the present disclosure relating to a method for training a local neural network model based on federated learning is disclosed with reference to FIG. 4. Referring to FIG. 4, the processor of the present disclosure may perform a plurality of operations to achieve the purpose of training a local neural network model based on federated learning.

For example, the processor 110 may calculate a difference between the global neural network model and the local neural network model (S401). Here, the difference may be, for example, a difference between “the most recently aggregated global neural network model” and “the local neural network model generated by applying additional training to the global neural network model based on local data”. As described above, as the difference between the neural network model and the local neural network model increases, the performance of federated learning may decrease, so the correlation based on the difference may be utilized to determine additional regularization of the federated learning.

The processor 110 may determine an additional regularization for training the local neural network model based on the calculated difference (S402). In this case, the additional regularization may be for the purpose of correcting a loss value that directly affects the training of the local neural network model.

The processor 110 may train the local neural network model based on the loss function including the determined additional regularization (S403). In this case, the processor 110 trains the local neural network model based on the loss function including the additional regularization, thereby decreasing the difference with the global neural network model compared to the case where the additional regularization is not applied. In other words, the processor 110 trains the local neural network model based on the loss function including the additional regularization, so that it is possible to prevent the local neural network model from being over-optimized only for local data while being out of the optimization range for the entire data distribution.

Meanwhile, a difference between the local neural network model and the global neural network model may occur for all layers of the neural network model. At this time, since determining the additional regularization based on the layer with the largest difference has the highest discrimination, it is necessary to identify the layer having the largest difference.

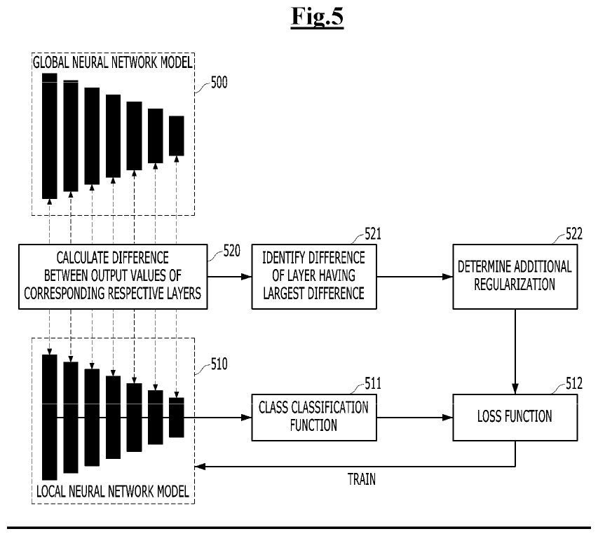

An exemplary embodiment according to the above necessity is disclosed with reference to FIG. 5. Referring to FIG. 5, the processor 110 may calculate 520 differences between an output value of each layer of the global neural network model and an output value of each corresponding layer of the local neural network model. In this case, it is assumed that the layers included in the global neural network model 500 and the local neural network model 510 and the number of nodes in each layer are the same in the size and structure because the local neural network model 510 is assigned as the global neural network model 500. Also, the processor 110 may calculate the differences between the output values of the respective layers based on various methods. For example, the processor 110 may calculate the differences by applying a direct subtraction operation to the output values of the respective layers. Further, in order to clearly evaluate differences in terms of optimization related to inference of the neural network model, the processor 110 may also calculate a difference between “a value obtained by applying a normalized class classification function to the output value of each layer of the global neural network model 500 and taking a logarithm” and “a value obtained by applying a normalized class classification function 511 to the output value of each layer of the local neural network model 510 and taking a logarithm”.

Next, the processor 110 may identify the largest difference among the differences calculated between the respective layers. Further, the processor 110 may make a determination 522 of an additional regularization based on the difference 521 of the layer identified as having the largest difference. Finally, the processor 110 may train the local neural network model 510 by using the loss function 512 in which the determined additional regularization is reflected.

Previously, when an experiment was conducted on the layer where the largest difference between the global neural network model and the local neural network model occurred, it was confirmed that the largest difference occurred in the last layer of the neural network model. Therefore, adding the additional regularization to the loss function based on the difference between the last layer of the global neural network model and the last layer of the local neural network model may be more effective in solving problems, such as catastrophic forgetting and client drift, and improving the performance of federated learning.

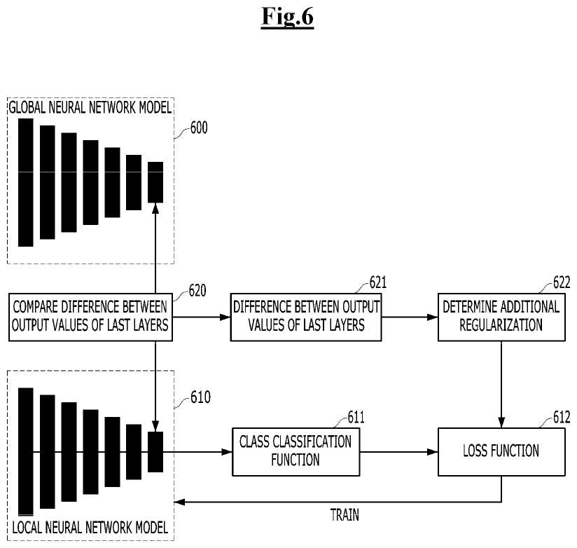

An exemplary embodiment in consideration of this point is disclosed with reference to FIG. 6. On the other hand, since the exemplary embodiment does not need to consider all layers of the neural network model, the effect of consuming relatively small processor resources may also be additionally implemented. Referring to FIG. 6, the processor 110 may compare 620 a difference between the last layer of the global neural network model and the last layer of the local neural network model. In addition, the processor 110 may calculate a difference 621 between the output values of the last layers based on the comparison 620 between the last layers, and the processor 110 may determine 622 an additional regularization for correction of the loss function based on the calculated difference. Also, the processor 110 may generate a modified loss function by adding the determined additional regularization to the loss function 612. Finally, the processor 110 may train the local neural network model 610 using the corrected loss function.

Meanwhile, the exemplary embodiment for determining a layer for determining an additional regularization is not limited thereto, and various exemplary embodiments may be implemented. For example, the processor 110 may also impose an additional regularization on the loss function based on a difference between a “predetermined layer” of the global neural network model and a “predetermined layer” of the local neural network model. Here, the “predetermined layer” may be a layer known or expected to have a large difference between the global neural network model and the local neural network model based on prior knowledge, experiments, simulations, or the like.

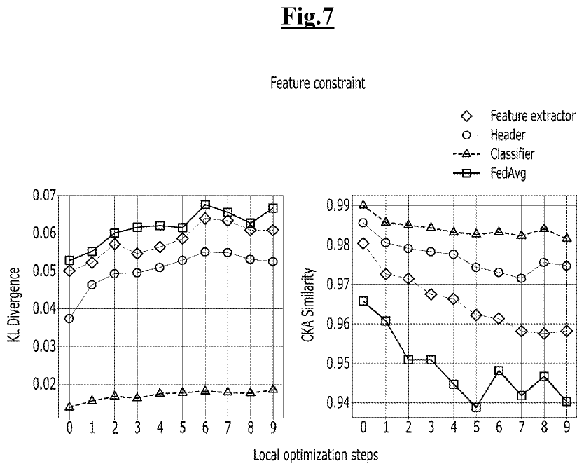

Previously, the exemplary embodiments of the present disclosure in which the layer for obtaining the difference between the global neural network and the local neural network is determined, and the additional regularization is determined by calculating the difference between the global neural network and the local neural network for the layer has been disclosed. In the following, in performing federated learning in a heterogeneous environment, federated learning using the additional regularization and federated learning using no additional regularization were tested by the method of the exemplary embodiment of the present disclosure, and the results of the test are be described based on FIG. 7 and Table 1.

In the federated learning, which is the comparison reference in the test, the accuracy was measured by aggregating the training parameters of 10 local neural network models into one global neural network model in a heterogeneous environment. In addition, in the test, predetermined Non-IID training data (for example, Non-IID training data generated based on a Dirichlet distribution having a concentration parameter β) was applied to each local neural network model to construct a heterogeneous environment.

TABLE 1

| | Accuracy of the method | |
|---|---|---|
| | according to the exemplary | Accuracy of |
| | embodiment of the disclosure | reference |
| Layer to obtain difference | (comparison with reference) | (FedAvg) |
| Feature extraction layer | 68.9 ± 0.3(−0.2) | 69.1 ± 0.6 |
| (Feature extractor) | | |
| Inupt layer (Header) | 69.6 ± 0.5(+0.5) | |
| Last layer (Classifier) | 70.8 ± 0.4(+1.7) | |

Table 1 represents the comparison between the reference (that is, a method without additional regularization) and the method to which the additional regularization is applied according to the exemplary embodiment of the present disclosure) (in this case, a feature extraction layer (feature extractor), an input layer (header), and a last layer (classifier) are used as the layers for obtaining the difference by the method of the exemplary embodiment of the present disclosure).

Referring to Table 1, it could be confirmed that when the difference in the feature extraction layer is based, the accuracy is slightly lower than the reference, but in the case where the difference of the input layer is based and the case where the difference of the last layer is based, a significant improvement was confirmed compared to the reference. In particular, the case where the difference of the last layer is based showed the highest accuracy compared to the reference (there was 1.7 improvement compared to the reference).

Referring to FIG. 7, in the case where the additional regularization, which is the method according to the exemplary embodiment of the present disclosure, is applied, when compared with the reference ‘FedAvg’ (no additional regularization), in all of the exemplary embodiment based on the difference of the feature extraction layer (feature extractor), the exemplary embodiment based on the difference of the input layer (header), and the exemplary embodiment based on the difference of the last layer (classifier), KL divergence (Kullback-Leibler divergence) was measured lower than the reference in all local learning stages, and CKA similarity was measured higher than the reference. That is, it could be confirmed that, in all of the exemplary embodiments in which the additional regularization was reflected, the “difference (for example, drift) between the global neural network model and the local neural network model” was more mitigated than the reference (no additional regularization).

Previously, the exemplary embodiments of the method for calculating the difference between the global neural network model and the local neural network model have been disclosed. Below, with reference to Equations 1 to 4, more detailed exemplary embodiments of the above-mentioned exemplary embodiments are disclosed.

An exemplary embodiment of the method of comparing 620 the output values of the last layers and outputting a difference 621 between the output values of the last layers performed by the processor 110 is described with reference to Equation 1 below.

f_{D}^{y}^{ᵢ}(xᵢ)=log(σ(f_{P}^{y}^{ᵢ}(xᵢ))−log(σ(f_{G}^{y}^{ᵢ}(xᵢ)) [Equation 1]

Equation 1 represents the exemplary embodiment related to the operation S401 of calculating the difference, and referring to Equation 1 above, f_{D}(⋅) means the difference between the global neural network model and the local neural network model, and f_{P}(⋅) and F_{G}(⋅) mean the output of the local neural network model and the output of the global neural network model, respectively. Also, these outputs may preferably be outputs of the last layer of the neural network model. In addition, a refers to a normalized class classification function, and the class classification function may include a softmax function, but is not limited thereto.

That is, the processor 110 may calculate the difference between “a value obtained by taking a logarithm after applying the normalized class classification function based on the output value of the last layer of the global neural network model” and “a value obtained by taking a logarithm after applying the normalized class classification function to the output value of the last layer of the local neural network model”.

In this case, the difference calculated by the processor 110 may be an indicator of how different the direction of learning is between the current local neural network model and the global neural network model.

The normalized class classification function corresponds to a classification function that is based on an existing class classification function, but is learned by normalizing the size of a parameter in a learning process. The present disclosure utilizes the normalized class classification function in the process of calculating (or estimating) the “difference (for example, drift) between the global neural network model and the local neural network model”, so that it is possible to solve the problem in that the difference may vary depending on the size of the parameters of the neural network layer, and this allows the difference to be more accurately calculated (or estimated).

On the other hand, the normalized class classification function may be implemented in the form of calculating an output value by utilizing the angle between an input vector and a vector indicating the class of the last layer, and an exemplary embodiment related thereto will be described with reference to Equation 2 below.

$$σ ( {f}^{yi} ( {x}_{i} ; ω ) ) = \frac{{e}^{cos {θ}_{i} / τ}}{{\sum }_{k = 1}^{\vert Y \vert} {e}^{cos {θ}_{k} / τ}} \qquad [ Equation 2 ]$$

Equation 2 expresses the normalized class classification function (σ(⋅), and θᵢ may mean an angle between the input vector and the vector indicating the i^{th} class of the last layer. In this case, the angle between the input vector and the vector indicating the i^{th} class of the last layer may be calculated through the inner product of the input vector and the vector representing the i^{th} class of the last layer.

Referring to Equation 2, the normalized class classification function may include dividing the normalized value for the i^{th} class of the last layer by the sum of the normalized values for all classes (Y classes).

In the exemplary embodiment related to the aforementioned operation S402, in the operation of determining the additional regularization for training the local neural network model based on the calculated difference, the processor 110 may perform: an operation of obtaining a negative value (−D) of the calculated difference (D); and an operation of determining the additional regularization by utilizing the negative value (−D) of the calculated difference (D). The additional regularization is described with reference to Equation 3 below.

R^{yi}(xᵢω)=−σ(−f_{D}^{yi}(xᵢ))·log((σ(f_{P}^{yi}(xᵢ)) [Equation 3]

Equation 3 is an expression of the additional regularization (R(⋅)) that the processor 110 may determine (in this case, ‘yi’ in Equation 3 means an output for the i^{th} class).

Referring to Equation 3, the additional regularization R(⋅) may include a product (⋅) of “a value obtained by using the normalized class classification function (−σ(⋅)) taking a negative number based on the negative value (−f_{D}(⋅)) of the calculated difference (f_{D}(⋅))”; and “a log value of the value obtained by using the normalized class classification function (σ(⋅)) based on the output value of the last layer of the local neural network model (fₚ(⋅))”.

On the other hand, the additional regularization (R(⋅)) has the form of “a normalized class classification function (−σ(⋅)) taking a negative number” for minimization through training, and uses the negative value (−f_{D}(⋅)) of the difference (f_{D}(⋅)) in order to implement the opposite direction of the difference (that is, a direction approaching the global neural network model). The additional regularization (R(⋅)) may induce the training of the local neural network model to be optimized in the opposite direction of the difference (f_{D}(⋅)).

In an additional exemplary embodiment related to operation S402, in determining the additional regularization, the processor 110 may determine the additional regularization by additionally adding a hyper-parameter (λ_{R}) for adjusting the intensity of the regularization. In this case, the hyper-parameter (λ_{R}) may be determined by the processor 110 to be proportional to the heterogeneous environment distribution of the data related to the federated learning. For example, the hyper-parameter (λ_{R}) may be determined larger as the difference between the distribution of training data of the local neural network model and the distribution of training data of the global neural network model increases, and through this, the optimization performance of the local neural network model may be improved. By additionally adding the hyper-parameter (λ_{R}), the processor 110 trains the local neural network in consideration of the additional regularization, but may adjust the severity of the additional regularization. This helps the processor 110 to effectively induce the local neural network model not to change significantly from the global neural network model by considering the heterogeneous environment distribution, and to reduce the catastrophic forgetting phenomenon described above. Further, when the local neural network models are aggregated into the global neural network model, the addition of the hyper-parameter (λ_{R}) helps the global neural network model to converge well to the optimal value.

In the exemplary embodiment related to operation S403, the processor 110 trains the local neural network model (fₚ(⋅)) based on the loss function, and the loss function may have a feature of outputting a loss value so that the local neural network model (f_{P}(⋅)) is trained in a direction to reduce the difference (f_{D}(⋅)) between the global neural network model (f_{G}(⋅)) and the local neural network model (f_{P}(⋅)).

The loss function for the exemplary embodiment is described with reference to Equation 4 below.

$$L ( T , ω ) = - {\sum }_{i = 1}^{\vert T \vert} {\sum }_{j = 1}^{\vert Y \vert} {y}_{ij} \cdot log σ ( {f}^{{y}_{j}} ( {x}_{i} ) ) + {λ}_{R} \cdot {R}^{{y}_{i}} ( {x}_{j} ; ω ) \qquad [ Equation 4 ]$$

Equation 4 expresses the loss function (L(⋅), and referring to Equation 4, the loss function (L(⋅)) may include a cross-entropy loss value related to all training data (T) and all classes (Y) of the last layer of the local neural network model, and the value (R(⋅)) based on the additional regularization. In addition, the value (R(⋅)) based on the additional regularization may be further multiplied by the hyper-parameter (λ_{R}), and through this, the speed of training may be adjusted in consideration of the heterogeneous environment distribution.

This is to correct the degree of training according to the degree of difference between the local neural network and the global neural network when the processor 110 trains the local neural network model, and it is possible to prevent the excessive difference between the local neural network model and the global neural network model.

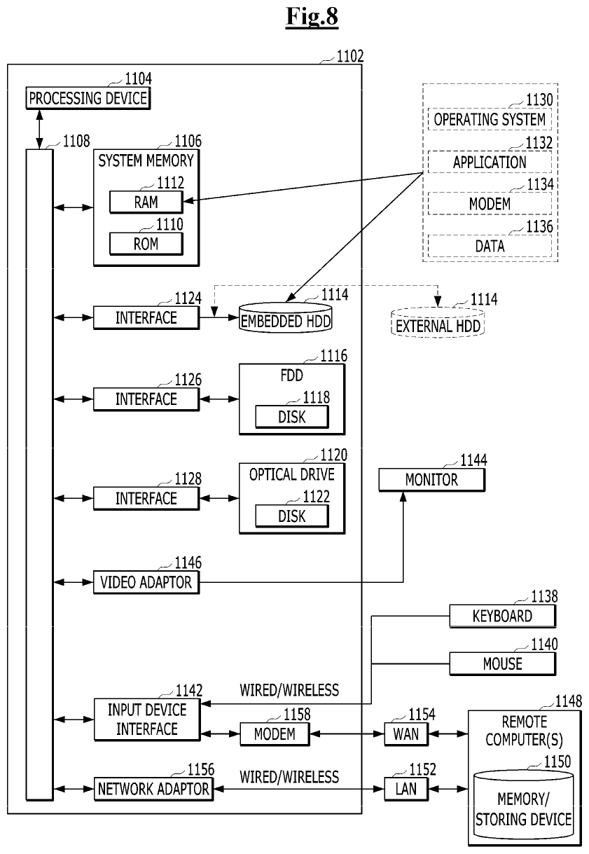

FIG. 8 is a simple and general schematic diagram illustrating an example of a computing environment in which the exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.1 Tb) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method of training a local neural network model based on federated learning, the method being performed by at least one computing device, the method comprising:
calculating a difference between a global neural network model and a local neural network model;
determining an additional regularization for training the local neural network model based on the calculated difference; and
training the local neural network model based on a loss function including the determined additional regularization.

2. The method of claim 1, wherein the calculating of the difference between the global neural network model and the local neural network model includes:
calculating differences between output values of respective layers of the global neural network model and output values of corresponding respective layers of the local neural network model; and
identifying the largest difference among the calculated differences.

3. The method of claim 1, wherein the calculating of the difference between the global neural network model and the local neural network model includes calculating a difference between an output value of a last layer of the global neural network model and an output value of a last layer of the local neural network model.

4. The method of claim 1, wherein the calculating of the difference between the global neural network model and the local neural network model includes calculating a difference between an output value of a predetermined layer of the global neural network model and an output value of a predetermined layer of the local neural network model.

5. The method of claim 3, wherein the calculating of the difference between the output value of the last layer of the global neural network model and the output value of the last layer of the local neural network model includes calculating difference between a value obtained by applying a normalized class classification function to the output value of the last layer of the global neural network model and taking a logarithm and a value obtained by applying the normalized class classification function to the output value of the last layer of the local neural network model and taking a logarithm.

6. The method of claim 5, wherein the normalized class classification function calculates an output value by utilizing an angle between an input vector and a vector indicating a class of the last layer.

7. The method of claim 1, wherein the determining of the additional regularization for training the local neural network model based on the calculated difference includes:
obtaining a negative value (−D) of the calculated difference (D); and
determining the additional regularization by using the negative value (−D) of the calculated difference (D).

8. The method of claim 7, wherein the additional regularization is determined based on:
a value obtained by applying a normalized class classification function to an output value of the last layer of the local neural network model and taking a logarithm; and
a value obtained by applying the normalized class classification function to the negative value (−D) of the calculated difference (D).

9. The method of claim 8, wherein the additional regularization is determined additionally based on a hyper-parameter for adjusting intensity of the regularization.

10. The method of claim 9, wherein the hyper-parameter is determined to be proportional to a heterogeneous environment distribution of data related to the federated learning.

11. The method of claim 1, wherein the loss function includes a cross entropy loss value and a value based on the additional regularization, and
the local neural network model is trained in a direction to reduce a difference between the global neural network model and the local neural network model while learning local data based on the loss function.

12. An apparatus for training a local neural network model based on federated learning, the apparatus comprising:
a processor including one or more cores; and
a memory,
wherein the processor configured to:
calculate a difference between a global neural network model and the local neural network model,
determine an additional regularization for training the local neural network model based on the calculated difference, and
train the local neural network model based on a loss function including the determined additional regularization.

13. A computer program stored in a non-transitory computer-readable storage medium, the computer program causing a processor to perform operations for training a local neural network model based on federated learning, the operations comprising:
calculating a difference between a global neural network model and the local neural network model;
determining an additional regularization for training the local neural network model based on the calculated difference; and
training the local neural network model based on a loss function including the determined additional regularization.
